(19) United States
(12) Patent Application Publication
(10) Pub. No.: US 2026/0178662 A1
(43) Pub. Date: Jun. 25, 2026

(54) INFORMATION PROCESSING APPARATUS

(71) Applicant: CANON KABUSHIKI KAISHA, Tokyo (JP)

(72) Inventor: NAOKI YAMAMOTO, Kanagawa (JP)

(21) Appl. No.: 19/409,286

(22) Filed: Dec. 4, 2025

(30) Foreign Application Priority Data
Dec. 23, 2024 (JP) 2024-226780

(51) Int. Cl. G06F 16/787; G06F 16/78

(52) U.S. Cl. CPC G06F 16/787; G06F 16/7867

(57) ABSTRACT

An information processing apparatus configured to provide content to an external apparatus includes a reception unit configured to receive information corresponding to a scene selected from the content by a user, an acquisition unit configured to acquire geographical information corresponding to the selected scene represented by the received information corresponding to the scene, and a transmission unit configured to transmit the acquired geographical information corresponding to the selected scene to the external apparatus.

### BACKGROUND

### Field of the Technology

The present disclosure relates to an information processing apparatus.

### Description of the Related Art

Japanese Patent Laid-Open No. 2019-23923 describes a technology that displays a link to another image containing a product displayed in an image using an image recognition technology.

If a user wishes to know a location where content such as a picture was captured, the user can search for and identify the location using the image recognition technology described in Japanese Patent Laid-Open No. 2019-23923. However, if, for example, the user wishes to know locations where a plurality of scenes in moving image content was captured, the user needs to perform a search for each scene. In other words, the user is required to perform significant tasks to identify the location where each scene of the content was captured.

### SUMMARY

According to an aspect of the present disclosure, an information processing apparatus configured to provide content to an external apparatus includes a reception unit configured to receive information corresponding to a scene selected from the content by a user, an acquisition unit configured to acquire geographical information corresponding to the selected scene represented by the received information corresponding to the scene, and a transmission unit configured to transmit the acquired geographical information corresponding to the selected scene to the external apparatus.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are diagrams illustrating examples of system configurations.

FIGS. 2A to 2C are diagrams illustrating examples of hardware configurations of apparatuses.

FIGS. 3A to 3C are diagrams illustrating examples of service application screens.

FIGS. 4A to 4D are diagrams illustrating examples of service application screens.

FIGS. 5A and 5B are diagrams illustrating examples of map service screens.

FIG. 6 is a sequence diagram illustrating an example of a process during provision of a content service.

FIG. 7 is a sequence diagram illustrating an example of a process during generation of an image capture location map.

FIG. 8 is a flowchart illustrating an example of a process designed to issue a request to generate an image capture location map.

FIG. 9 is a flowchart illustrating an example of a process designed to generate an image capture location map.

FIGS. 10A and 10B are diagrams illustrating examples of screens configured to prompt a user to confirm an estimated image capture location.

FIG. 11 is a flowchart illustrating an example of a process designed to improve the accuracy of an image capture location.

FIG. 12 is a diagram illustrating an example of a screen used by a user to report an image capture location.

FIG. 13 is a flowchart illustrating an example of a process for generating an image capture location map in a case where there is a report history.

### DESCRIPTION OF THE EMBODIMENTS

The embodiments of the present disclosure will be described in detail below with reference to the drawings. It should be noted that the embodiments described below are not intended to limit the present disclosure recited in the claims, and not all combinations of features described in the embodiments are necessarily essential for solving issues related to the present disclosure.

In the present application, artificial intelligence (AI) refers to a computer system or software designed to imitate human intelligence. Functions such as learning, inference, problem-solving, perception, and language understanding are realized using the AI technology. There are various technologies and methods for realizing the AI functions, such as machine learning, neural network, natural language processing, robotics, and pattern recognition, and using these technologies enables various applications, such as data analysis, automation tasks, image recognition, and speech recognition.

In the present application, generative AI refers to a technology that automatically generates various types of content similar to human creation, such as text, image, music, or video, by utilizing methods such as deep learning and machine learning.

### First Embodiment

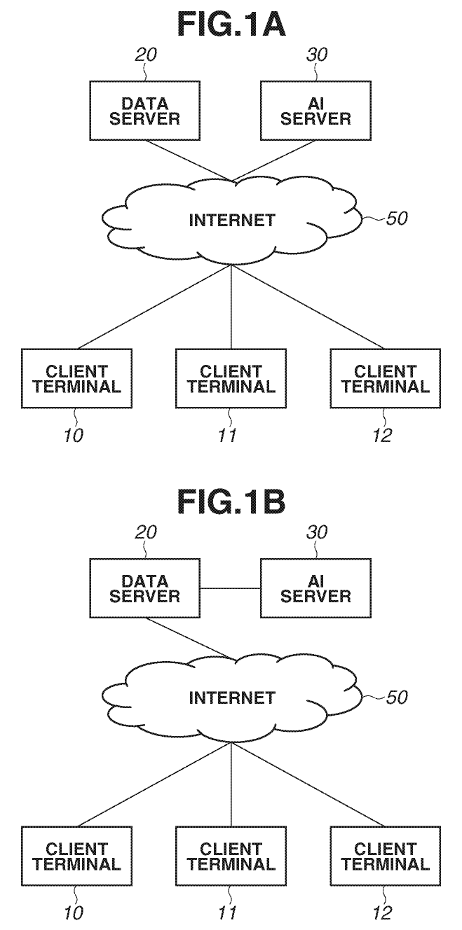

FIGS. 1A and 1B are diagrams illustrating examples of system configurations according to the present embodiment. According to the present embodiment, as illustrated in FIG. 1A, client terminals 10 to 12, a data server 20, and an AI server 30 are connected via the Internet 50 and can communicate with each other. In this system, the number of connected components may be any number, and the system may be composed of a plurality of combinations. The system constructs an information processing system using these configurations.

The client terminals 10 to 12 are information processing apparatuses, such as smartphones or personal computers (PCs). The client terminals 10 to 12 execute each program or application, thereby allowing a user to use various functions. The present embodiment will describe an example in which the user browses moving image content or a map using the client terminals 10 to 12.

The data server 20 is an information processing apparatus that is a type of server and communicates with various apparatuses, such as other computers or devices, via a network, such as the Internet 50, to transmit or receive data. According to the present embodiment, the data server 20 plays a role in providing a service for providing online content, such as a moving image, to be streamed on the client terminals 10 to 12, and in providing online content. In connection with this, the data server 20 also provides an application (service application) that is configured to provide the service and executed by the client terminals 10 to 12.

The AI server 30 is also an information processing apparatus that is a type of server and communicates with various apparatuses, such as other computers or devices, via a network, such as the Internet 50, to transmit or receive data. According to the present embodiment, the AI server 30 provides a generative AI function. The AI server 30 provides a service (map service) that performs image recognition on an image represented by received image data, acquires information from an information source (not illustrated), estimates location information, and generates a map based on the estimated location information.

The Internet 50 is a type of network and plays a role in mediating communication between connected apparatuses. Either a wired connection method using a wide area network (WAN), Ethernet, or the like or a wireless connection method using Wi-Fi or the like may be employed.

It is also possible to employ a system configuration illustrated in FIG. 1B. In this example, the data server 20 and the AI server 30 are connected via another network, such as a local area network (LAN), different from the Internet 50 via which the client terminals 10 to 12 are connected. At this time, the AI server 30 is not connected to the Internet 50. With this configuration, it is still possible to carry out the same communication as in the configuration illustrated in FIG. 1A, and in this case, the client terminals 10 to 12 and the AI server 30 can communicate via the data server 20.

The functions realized and services provided by the data server 20 and the AI server 30 according to the present embodiment may be realized by distributing the functions and services among a plurality of servers. On the other hand, in a case where the functions realized and services provided by the data server 20 and the AI server 30 can be realized by a single server or system, separate servers, as used in the present embodiment, are not required.

In particular, the map service provided by the AI server 30 may be configured so that, for example, the AI server 30 performs map generation and another server provides the subsequent service. While the client terminal 10 may be described as a representative of the client terminals 10 to 12 in the description of the present embodiment, this does not imply that one specific client terminal must be designated.

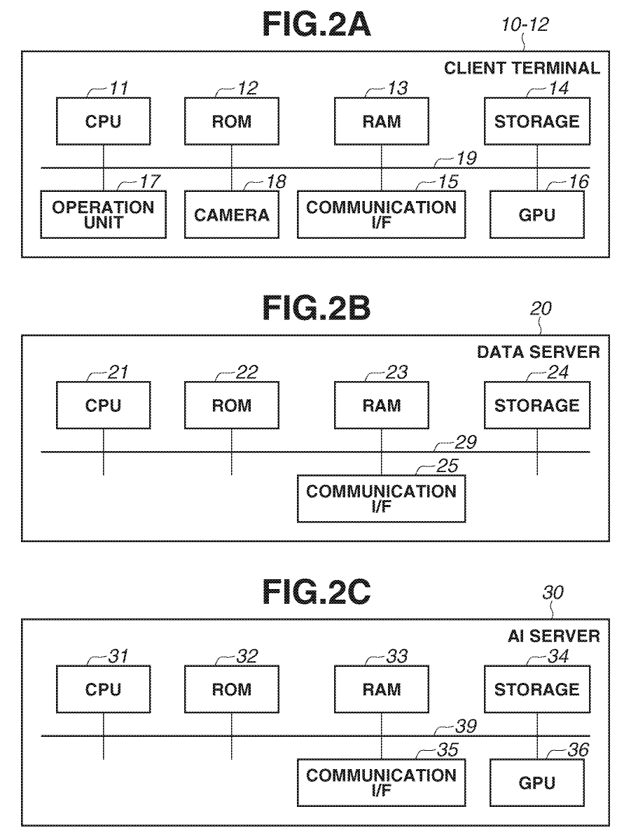

FIGS. 2A to 2C are diagrams illustrating examples of hardware configurations of each apparatus of the system according to the embodiment.

Specifically, FIGS. 2A to 2C are diagrams illustrating examples of hardware configurations of the client terminals 10 to 12, the data server 20, and the AI server 30.

FIG. 2A is a diagram illustrating an example of a hardware configuration of the client terminals 10 to 12. Each of the client terminals 10 to 12 according to the present embodiment includes a central processing unit (CPU) 11, a read-only memory (ROM) 12, a random access memory (RAM) 13, a storage 14, a communication interface (communication I/F) 15, a graphics processing unit (GPU) 16, an operation unit 17, and a camera 18.

The CPU 11 is a central processing unit configured to control each component and execute processing, such as computation, based on various programs, such as an application program or software program stored in a storage device, such as the ROM 12 or the storage 14. The CPU 11 exchanges a control signal or the like with each component connected to the CPU 11 via a bus 19 to enable communication between the CPU 11 and the component, thereby controlling the component. For example, the CPU 11 controls the communication I/F 15 to enable data exchange between this apparatus and another apparatus connected to this apparatus.

Further, the CPU 11 executes various programs based on an instruction input by the user via the operation unit 17 and processes data. Furthermore, the CPU 11 executes various processes based on an instruction, such as a control command, received from an external apparatus via the communication I/F 15.

The ROM 12 is a type of nonvolatile memory configured to store various programs, such as an application program or software program, to be read by the CPU 11. The RAM 13 is a type of volatile memory configured to function as a main memory for the CPU 11, a work area, and the like.

The storage 14 is a type of storage medium configured to store various programs and various data, such as image data and moving image data, and includes, for example, a hard disk drive (HDD), a solid state drive (SSD), or the like. The storage 14 has, for example, a function that stores (records, saves) data input to the storage 14 and outputs the stored data to an external component via communication with the CPU 11, and can change the stored contents. According to the present embodiment, the storage 14 stores a service application program configured to execute the service provided by the data server 20.

The communication I/F 15 is an interface configured to connect each component of the apparatus, including the CPU 11, to an external apparatus via the Internet 50 and realize network communication.

The GPU 16 is a computation unit that includes an image processing processor and is configured to perform high-speed parallel processing of complex mathematical calculations.

The operation unit 17 includes, for example, a button, a keyboard, a touch panel, and the like, and the CPU 11 receives an instruction from the user via the operation unit 17. The operation unit 17 may further include a display, and the client terminals 10 to 12 may display information on the display or the touch panel (a display unit) to convey the information to the user. According to the present embodiment, the content, such as a moving image, provided by the data server 20 is displayed on the operation unit 17, and the user can issue, for example, an instruction to select or reproduce a moving image via the operation unit 17.

The camera 18 is a device configured to convert light into an electrical signal and record the electrical signal as digital data (image data) and can capture an image or moving image. Captured image data can be stored in the storage 14.

The client terminals 10 to 12 may be apparatuses, such as projectors, configured to display a screen by projecting light onto a screen portion or the like. In this case, the client terminals 10 to 12 include a light emitting unit, a lens unit, and the like to perform the function. In this case, a screen displayed on the operation unit 17 hereinafter is projected onto the screen portion by the projector.

FIG. 2B is a diagram illustrating an example of a hardware configuration of the data server 20. The data server 20 according to the present embodiment includes a CPU 21, a ROM 22, a RAM 23, a storage 24, and a communication I/F 25. These components have similar configurations and functions to those described above with reference to FIG. 2A, so that the description will be omitted.

FIG. 2C is a diagram illustrating an example of a hardware configuration of the AI server 30. The AI server 30 according to the present embodiment includes a CPU 31, a ROM 32, a RAM 33, a storage 34, a communication I/F 35, and a GPU 36. These components have similar configurations and functions to those described above with reference to FIG. 2A, so that the description will be omitted. The GPU 36 of the AI server 30, for example, performs a computation to convert input image or text data using a large language model (LLM) based on a control command received from the CPU 31.

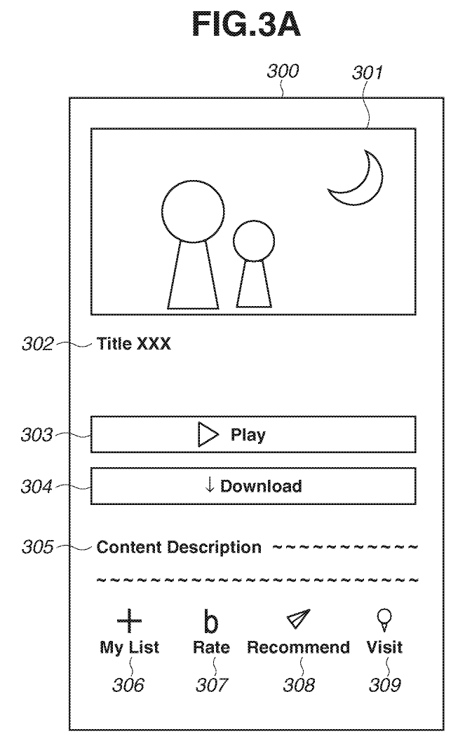

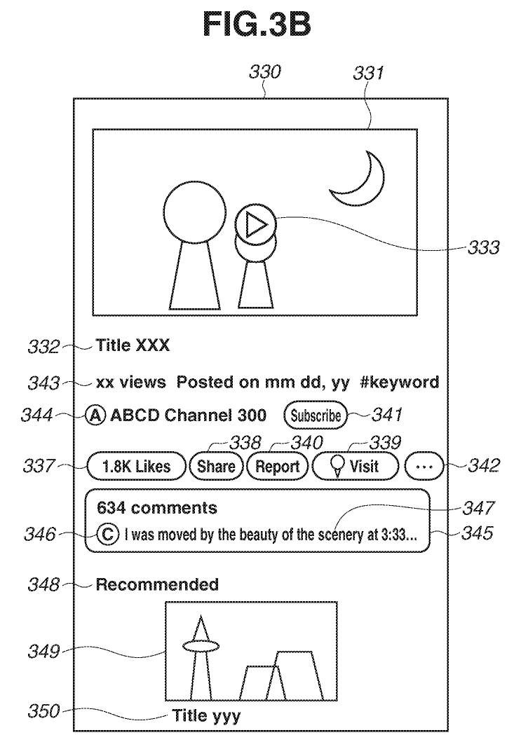

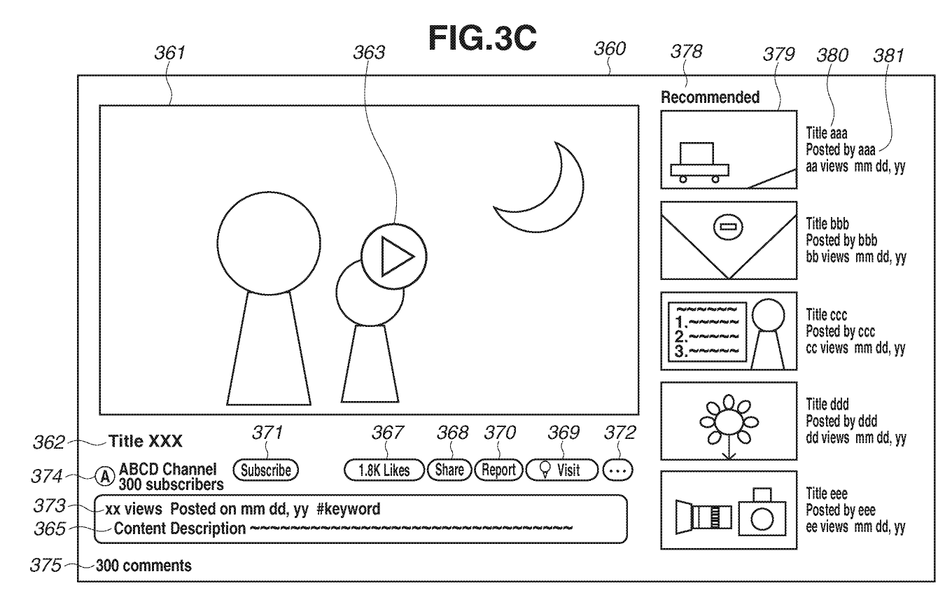

FIGS. 3A to 3C are diagrams illustrating examples of service application screens provided by the data server 20. Screens 300, 330, and 360 respectively illustrated in FIGS. 3A, 3B, and 3C are examples of screens displayed on the operation unit 17 of the client terminal 10.

Since the service application varies depending on the vendor providing the service and the type of content handled, several examples are illustrated. The screen 300 illustrated in FIG. 3A is an example of a service application screen used by a service that provides content, such as a film, drama, or animation, produced by a group of experts. On the other hand, the screen 330 illustrated in FIG. 3B is an example of a service application screen used by a service that provides content such as a moving image that even an individual can share with another individual, without being limited to the above-described genres. In the case of such a service, the vendor of the service issues an account to the user, and the user can post content using the account.

Since the display of a screen provided by the same service application from the same vendor varies depending on the type of the client terminal 10 displaying the screen and the orientation of the client terminal 10 (the operation unit 17), several examples are illustrated. The screen 330 illustrated in FIG. 3B is an example of a service application screen displayed on the operation unit 17 of the client terminal 10 such as a smartphone or compact tablet terminal. On the other hand, the screen 360 illustrated in FIG. 3C is an example of a service application screen displayed on the operation unit 17 of the client terminal 10 such as a personal computer (PC), large tablet terminal, or projector.

FIG. 3A is a diagram illustrating a first example of the service application screen provided by the data server 20. The screen 300 is a screen including various objects, areas, and other items described below.

The screen 300 is a screen that is displayed in a case where content is selected by the user on a content selection screen (not illustrated) and displays the selected content information.

An area 301 is an area where an image that is commonly referred to as a thumbnail and is a representative image of the content or an image representing a portion of the content is displayed. The image displayed in the area 301 is not limited to a still image and may be, for example, a moving image (media in which images are switched and displayed to create the appearance of visually continuous motion) or other images.

A title field 302 is an area where a character string specifying a title of the content displayed on the screen 300 is displayed. The format of the title displayed in the title field 302 is not limited to the character string. In a case where the title of the content is represented by, for example, a designed element such as a logo, this image may be displayed in the title field 302.

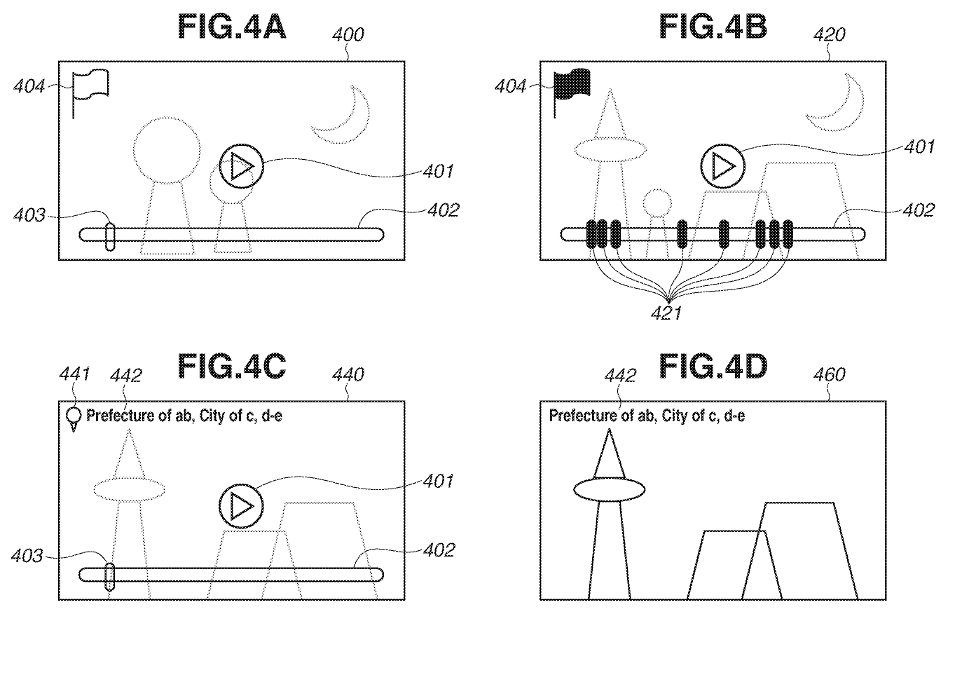

An object 303 is an object that is commonly referred to as a play button, and pressing the object 303 initiates the provision of the content. Specifically, the content is displayed or reproduced within the area 301 in a state where the screen 300 is displayed on the operation unit 17 of the client terminal 10. Alternatively, a screen illustrated in FIGS. 4A, 4B, 4C, or 4D is displayed across a surface of the operation unit 17 of the client terminal 10, thereby displaying or reproducing the content. According to the present embodiment, the content is displayed/reproduced in a state where the data server 20 and the client terminal 10 are connected. On the other hand, in a case where the data server 20 and the client terminal 10 are no longer connected, the display or reproduction is not performed (stopped) in the present description.

An object 304 is an object that is commonly referred to as a download button, and in a case where the object 304 is pressed, the content displayed on the screen 300 is recorded in the storage 14 of the client terminal 10. This makes it possible to display or reproduce the content stored in the storage 14 on the client terminal 10 even in a state where the data server 20 and the client terminal 10 are no longer connected, as described above with reference to the object 303.

A description field 305 is an area where a character string describing the content displayed on the screen 300 is displayed. Examples of the character string describing the content include a summary of the content, a performer, the publication date, the number of views, a keyword, a tag, the number of ratings, and a review. It is not necessary to display the entire description in the description field 305, and a configuration may be employed in which a portion of the description is initially displayed in the description field 305 and the hidden portion of the description is displayed in a case where the description field 305 is selected.

An object 306 is an object that is commonly referred to as a list registration button, and the button is for storing the content displayed on the screen 300 in a list corresponding to a user account. The object 306 may be a favorite button or flag, and in a case where the favorite button or flag is pressed, the content is stored in the list in a similar way. This allows the user to access the content from the list when the user wishes to browse the content later or again, which improves usability.

An object 307 is an object that is commonly referred to as a rate button and is used to rate the content displayed on the screen 300. For example, a thumbs-up icon is used as the object 307, and in a case where, for example, the user likes the content, the user can provide a positive rating by selecting the object 307. A thumbs-down icon may also be used as the object 307, and in this case, selecting the object 307 provides a negative rating. There may be a plurality of objects 307.

An object 308 is an object that is commonly referred to as a share button and is used to transmit the content information displayed on the screen 300 to another user.

In a case where the object 308 is pressed, another function or application available on the client terminal 10 is displayed, and the user can transmit the content information by selecting or inputting a displayed function or application to be used and a destination.

An object 309 is an object for displaying position information regarding the content, such as the place where the content displayed on the screen 300 was captured. According to the present embodiment, the object 309 is provisionally named the “visit” button and displayed, and in a case where the object 309 is selected, a map described below is eventually generated and displayed.

FIG. 3B is a diagram illustrating a second example of a service application screen provided by the data server 20. The screen 330 is a screen including various objects and areas that will be described.

The screen 330 is a screen that is displayed in a case where content is selected by the user on the content selection screen (not illustrated) and displays the selected content information.

An area 331 is similar to the area 301. A title field 332 is similar to the title field 302. An object 333 is similar to the object 303. An object 337 is similar to the object 307, and in the example illustrated in FIG. 3B, the object 337 specifies a received rating as a numeric value. An object 338 is similar to the object 308. An object 339 is similar to the object 309.

An object 340 is an object that is commonly referred to as a report button and is used to report the vendor if the content displayed on the screen 330 violates the terms and conditions of the service application or is inappropriate for public disclosure. In a case where the object 340 is selected, the content information displayed on the screen 330 is transmitted to the vendor to prompt the vendor to check the content and take an appropriate measure, such as unpublishing the content.

An object 341 is an object that is commonly referred to as a registration button, and the account that has provided (uploaded) the content displayed on the screen 330 can be registered with the object 341. The difference between the object 341 and the object 306 in FIG. 3A is that while pressing the object 306 stores the content information, pressing the object 341 stores (registers) information about the account that has provided the content.

This enables the user to receive a notification in a case where, for example, the registered account provides new content. The information about the account that has provided the content is described in an area 344, which will be described below.

An object 342 is an object that is commonly referred to as an ellipsis mark or the like and is used to execute another function provided by the service application. In a case where the object 342 is selected, a menu (not illustrated) that is not displayed when the screen 330 is displayed is displayed, and the user can select a function to be executed from the menu, thereby executing the function.

An area 343 is one of the areas where information about the content displayed on the screen 330 is displayed, and according to the present embodiment, the number of times the content was viewed, the date on which the content was provided, a keyword that is referred to as a hashtag and used for search, and other information are displayed. Details of the display are not limited to those described above.

The area 344 is an area where information about the account that has provided (posted) the content displayed on the screen 330 is displayed, and according to the present embodiment, an icon of the account, a name of the account, and the number of subscribers are displayed. In a case where the area 344 is selected, for example, a screen configured to display a profile of the account is displayed.

The subscriber refers to an account registered by pressing the object 341 or an account that has selected a similar registration button on the profile screen, and the number of subscribers refers to the total number of these accounts.

An area 345 is an area that is commonly referred to as a comment field and where a list of comments posted on the content displayed on the screen 330 is displayed, and according to the present embodiment, the total number of posted comments and some of the comments are displayed. By selecting the area 345, the user can see the comments that are hidden when the screen 330 is displayed.

An icon 346 represents a user icon of the user having posted text 347, which will be described. The text 347 is a comment posted by the account corresponding to the icon 346, and the character string “3:33” indicates that the comment is about a scene at 3 minutes and 33 seconds in the moving image content.

An area 348 is an area where content related to the content displayed on the screen 330 or content recommended to the user having displayed the screen 330 is displayed. Content in the same or similar genre is displayed based on the information about the content, or content that the user is most likely to browse next is displayed based on the results of analyzing the user using the service application.

An area 349 is an area where an image that is commonly referred to as a thumbnail and is a representative image of related content or an image representing a portion of the content is displayed. The image displayed in the area 349 is not limited to a still image and may be, for example, a moving image (media in which images are switched and displayed to create the appearance of visually continuous motion) or other images. A title field 350 is an area where a character string specifying a title of the related content is displayed.

FIG. 3C is a diagram illustrating a third example of a service application screen provided by the data server 20. The screen 360 is a screen including various objects and areas that will be described. The screen 360 is a screen that is displayed in a case where content is selected by the user on the content selection screen (not illustrated) and displays the selected content information.

An area 361 is similar to the area 331. A title field 362 is similar to the title field 332. An object 363 is similar to the object 333. A description field 365 is similar to the description field 305. An area 373 is similar to the area 343. An area 374 is similar to the area 344. An area 375 is similar to the area 345. An area 378 is similar to the area 348. An area 379 is similar to the area 349. A title field 380 is similar to the title field 350. An area 381 is an area where information about the content specified in the title field 380 is displayed, and details of the displayed information are similar to those in the description field 365.

FIGS. 4A to 4D are diagrams illustrating examples of the service application screen that is provided by the data server 20 and where content is displayed or reproduced. Screens 400 to 460 are displayed on the operation unit 17 of the client terminal 10 in a case where, for example, the object 303, 333, or 363 is pressed. An example will be described with reference to four patterns of the screen.

In the examples of the screens 400, 420, and 440, the reproduction of moving image content is paused, and each object (menu) is displayed. On the other hand, the example of the screen 460 is an example of a diagram illustrating a single moment of moving image content being reproduced as a result of an object 401 being selected, and in the actual service application, the content progresses even without any user operation after the object 401 is selected. The examples described below with reference to the screens 400, 420, and 440 do not have to be operations that are performed in a paused state, and may be performed in a situation where the content is being reproduced, as in the description of the screen 460.

The object 401 on the screen 400 illustrated in FIG. 4A is an object that is commonly referred to as a play button, and in a case where the object 401 is pressed, the provision of the content starts. Specifically, the content is displayed or reproduced in a state where the screen 400 is displayed on the operation unit 17 of the client terminal 10.

An object 402 is an object that is commonly referred to as a seek bar and used together with an object 403, and in a case where, for example, the content is a moving image, the object 402 plays a role in displaying time.

The object 403 is an object that is commonly referred to as a slider and used together with the object 402 to play a role in displaying, for example, an elapsed time or the like in a case where the content is a moving image, or a completion status or the like in a case where the content is a game. The object 403 serves the function by moving right and left on the object 402.

An object 404 is an object that is commonly referred to as a flag, and in a case where the object 404 is selected, information about the content displayed when the object 404 is selected is recorded. In other words, the object 404 is an object for accepting selection of a scene from the user. As described below, when a location (scene) that the user wishes to visit appears in the content being displayed or reproduced, the user can select the object 404 to identify the location displayed at that time. Specifically, selecting the object 404 causes the AI server 30 to generate a map based on the stored content information. The act of selecting the object 404 by the user is also referred to as setting a flag, storing, or clipping.

FIG. 4B is a diagram illustrating details of a state where the object 404 is selected. In FIG. 4B, the object 404 is being selected by the user and displayed with a different appearance than the object 404 in FIG. 4A. Specifically, the object 404 in FIG. 4B differs in color from the object 404 in FIG. 4A to allow the object 404 to be identified, and the user can recognize whether the object 404 is selected.

Each object 421 is an object for specifying that the object 404 is selected, and is a type of the object 403. The object 421 is displayed on, for example, the object 402, which specifies the elapsed time of the reproduced moving image content, when the object 404 is selected by the user. Even in a case where the content progresses, the object 404 remains displayed at the position indicating the selection time of the object 404. At this time, the position of the object 421 corresponds to the elapsed time of the content.

The screen 420 illustrates an example of a screen on which the content at the time corresponding to the position of the rightmost object 421 is displayed. Specifically, the screen 420 illustrates an example in which the scene at 3 minutes and 33 seconds of the moving image content with a total length of 5 minutes is displayed, as described below.

Thus, by checking the object 421, the user can recognize whether the object 404 is selected. Furthermore, in a case where the content is a moving image, the user can recognize the timing and number of points where the object 404 was selected.

FIGS. 4C and 4D are diagrams illustrating examples in which position information about the currently displayed scene of the reproduced content is displayed, and details will be described below in a second embodiment.

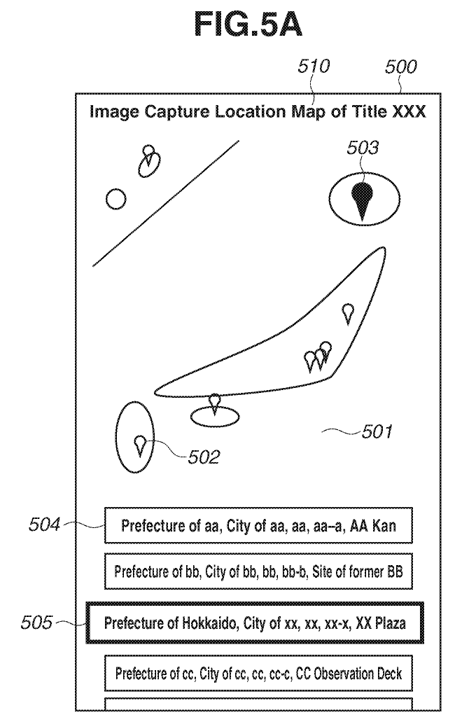

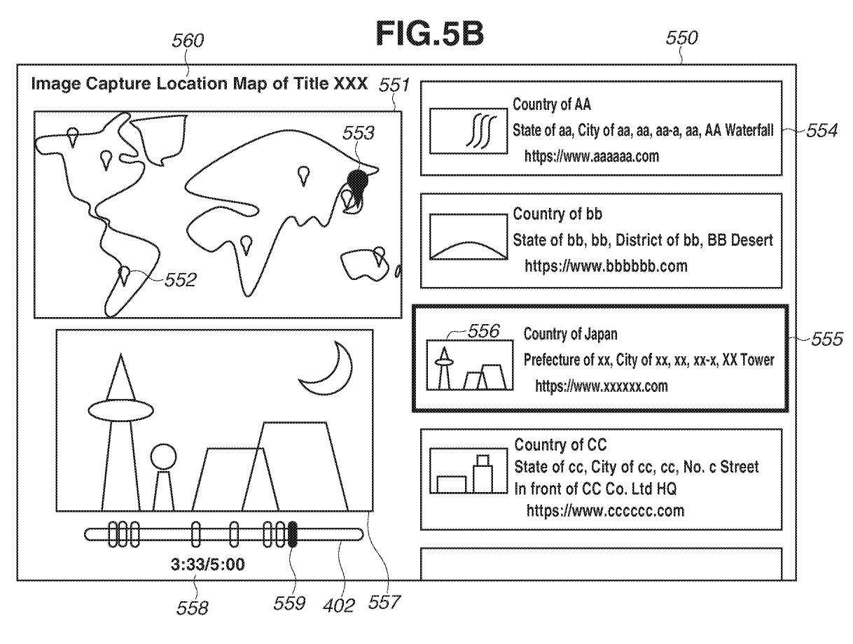

FIGS. 5A and 5B are diagrams illustrating examples of a map service screen that is generated by the AI server 30 and presents content position information. Screens 500 and 550 illustrated in FIGS. 5A and 5B, respectively, are examples of screens displayed on the operation unit 17 of the client terminal 10. These screens display maps including geographical information generated based on a flag set by the user.

Several examples are illustrated because the map service screen displays different information depending on, for example, the size of the operation unit 17 of the client terminal 10 that displays the screen. The map service screen may display the same information regardless of the client terminal 10.

The screen 500 illustrated in FIG. 5A herein is an example of the map service screen displayed on the operation unit 17 of the client terminal 10 such as a smartphone or compact tablet terminal. On the other hand, the screen 550 illustrated in FIG. 5B is an example of the map service screen displayed on the operation unit 17 of the client terminal 10 such as a PC, large tablet terminal, or projector.

FIG. 5A is a diagram illustrating a first example of the map service screen provided by the AI server 30. The screen 500 is a screen including various objects, areas, and other items described below and is displayed in a case where the object 309, 339, or 369 is selected by the user. In a case where the object 309, 339, or 369 is selected, position information corresponding to each scene for which the object 404 is selected and a flag is set in the content displayed on the corresponding screen is mapped and displayed on the screen 500.

An object 501 is an object representing a map, and a map of Japan is displayed on the screen 500. While an abstract map is displayed in the present application, a more accurate map with more precise shapes can be displayed in practice. Specifically, when a map is generated, the AI server 30 can acquire map data from a database (not illustrated) or service (not illustrated), and a map on the screen can be generated using the acquired map data. It is also possible to display an abstract map.

While the object 501 according to the present embodiment displays an abstract map of the entire country of Japan, this is not intended to be limiting. For example, the display position of an object 503 described below corresponds to Hokkaido. The object 501 may be configured to display a local map of Hokkaido in a case where, for example, all objects 502 to be displayed within the object 501 are displayed on the map of Hokkaido. The objects 502 will be described below.

While the objects 502 are displayed only in land areas in the example of the screen 500, an object 502 may be displayed in other areas such as river, ocean, glacier, and iceberg areas. For example, in a case where the user sets a flag on a photo-scene at sea, such as on a ship, and a map (the object 501) is generated based on the flag, an object 502 is displayed at a position on the map that corresponds to an estimated capture location of the scene.

This is realized in a case where, for example, a distinctive lighthouse, coastline, or breakwater on land appears in the background from the ship. An estimation method will be described below. Similarly, even in a case where a scene was captured underwater, if the underwater database is fully available and the AI server 30 can identify the image capture location during map generation, an object 502 is displayed at the identified position on the map.

The object 502 is an object that is commonly referred to as a pin and is displayed at a corresponding position on a map to provide a visual presentation of the position information to the user. According to the present embodiment, as illustrated in FIG. 4B, position information such as the image capture locations of the scenes corresponding to the flags (the objects 421) set in advance by the user is displayed on the map. Since eight flags are set in FIG. 4B, eight objects 502 (including the object 503) corresponding to the eight flags are displayed on the screen 500. The number is not limited to eight, and in a case where the user sets a predetermined number of flags, the predetermined number of objects 502 are displayed.

In other words, the objects 502 are displayed at the positions on the object 501 that correspond to all the scenes for which the flags are set by the user. As described below, in a case where the location of a scene for which a flag is set is not successfully estimated due to a failure in an image recognition process performed by the AI server 30, the object 502 that corresponds to a successfully estimated location is displayed.

The objects 502 correspond to areas 504 (including an area 505) described below, and detailed position information about the objects 502 is displayed in the areas 504. In a case where the user selects a pin that the user wishes to see detailed position information about, the selected object 502 is displayed so that, like the object 503, the selected object 502 can be distinguished from other pins. Furthermore, the position information corresponding to the selected pin (the object 503) is displayed so that, like the area 505, the position information can be distinguished from other areas 504.

The object 503 is one of the objects 502 (pins) and represents a pin that is displayed (highlighted and displayed) in a different color and size so that the pin can be distinguished from other pins in a case where an object 502 is selected by the user. While the color and size are changed so that the pin can be distinguished in the example according to the present embodiment, this is not intended to be limiting. For example, one of the color and size may be changed so that the pin can be distinguished, or an object 502 may be displayed with, for example, a border or background around the object 502 so that the object 502 can be distinguished from other objects 502.

In a case where the user next selects another pin (object 502), the selected pin is highlighted and displayed, as illustrated by the object 503, and the previously selected, highlighted, and displayed pin is displayed in its previous state before the pin was highlighted and displayed.

The area 504 is an area where detailed position information about the locations corresponding to the positions of the objects 502 displayed on the map of the object 501 is displayed. In other words, the area 504 is an area where position information corresponding to the scenes of the content for which the flags are set by the user is displayed. In the example of the screen 500, the object 501 presents a map of Japan, and position information corresponding to the positions where the objects 502 are displayed is displayed in the area 504. In the area 504, for example, an address, place name, facility name, and other information are displayed, but it is not required to display all of these. Further, information such as a postal code, latitude, or longitude may also be displayed.

The number of areas 504 generated matches the number of objects 502. In the example of the screen 500 illustrated in FIG. 5A, since eight objects 502 (including the object 503) are displayed, eight areas 504 are generated, but only four of the eight areas 504 are displayed due to the size of the operation unit 17. The areas 504 that are not currently displayed are displayed in a case where, for example, the user selects a corresponding object 502 or scrolls down the screen.

The area 505 is one of the areas 504 and illustrates an example of displaying position information corresponding to the selected object 503, and the area 505 is displayed (highlighted and displayed) so that the area 505 can be distinguished from the other areas 504. While the area 505 is displayed larger than the other areas and, furthermore, outlined with a bold border so that the area 505 can be distinguished in the illustrated example according to the present embodiment, this is not intended to be limiting. For example, one of the size and border width may be changed so that the area 505 can be distinguished, or the color of, for example, the border or background of the area 505 may be changed so that the area 505 can be distinguished.

As a result, the screen 500 is displayed so that the flag information set by the user by selecting the object 404, the display position of the object 503, and the highlighted and displayed area 505 correspond.

In a case where the user next selects another pin, an area where position information corresponding to the selected pin is displayed is highlighted and displayed, as illustrated by the area 505, and the area where the position information corresponding to the previously selected pin is displayed is displayed in its previous state before the area was highlighted and displayed.

In other words, as the object 502 that is selected by the user on the screen 500 changes, the object 502 (the object 503) that is highlighted and displayed and the area 504 (the area 505) that is highlighted and displayed also change accordingly.

A text 510 is a character string that displays a title and indicates the content to which the displayed image capture location map corresponds. In the illustrated example according to the present embodiment, a title is displayed following the rule: “Image Capture Location Map” + “of” + “the character string of the title of the content”.

FIG. 5B is a diagram illustrating a second example of the map service screen provided by the AI server 30. The screen 550 is a screen including various objects, areas, and other items that will be described below, and is displayed in a case where the object 309, 339, or 369 is selected by the user. In a case where the object 309, 339, or 369 is selected, position information corresponding to each scene for which the object 404 is selected and a flag is set in the content displayed on the corresponding screen is mapped and displayed on the screen 500.

An object 551 is an object representing a map, and a map of the world is displayed on the screen 550. Other features are similar to those of the object 501, so that the description will be omitted.

An object 552 is similar to the object 502. An object 553 is similar to the object 503.

An area 554 is similar to the area 504. In the example of the screen 550, the object 551 presents the map of the world, and position information corresponding to the positions where the objects 552 are displayed is displayed in the area 554. In other words, the area 554 is an area where position information corresponding to the scenes of the content for which the flags are set by the user is displayed. In the area 554, an image (an area 556) of the location, the name of the country, a uniform resource locator (URL) presenting information such as a website related to the location, and other information are displayed in addition to those in the example of the area 504, but it is not required to display all of these. Further, information such as a latitude and longitude may also be displayed.

An area 555, like the area 505, is one of the areas 554 and illustrates an example of displaying position information corresponding to the selected object 553, and the area 555 is displayed (highlighted and displayed) so that the area 555 can be distinguished from the other areas 554.

The area 556 is an area where an image of the location corresponding to the display position of the object 552 is displayed.

An area 557 is an area where a scene from the content flagged by the user in the service application is displayed. In other words, the same scene as that displayed on the screen 420 in FIG. 4B is displayed in the example illustrated in FIG. 5B. A scene corresponding to the position of an area 558, which will be described, is displayed.

The area 558 is an area where the time of the moving image content, the completion status of game content, or other information is displayed. In the example illustrated in FIG. 5B, the content is moving image content, and the character string “3:33/5:00” is displayed to indicate that the scene at 3 minutes and 33 seconds of the content with a total length of 5 minutes is displayed.

An object 559 is a slider and is similar to the object 421. In the example of the screen 550, the object 559 is displayed to correspond with the object 552 (the object 553) that is currently highlighted and displayed and the area 554 (the area 555) that is currently highlighted.

In other words, as the slider that is selected by the user on the screen 550 changes, the object 552 (the object 553) that is highlighted and displayed, the area 554 (the area 555) that is highlighted and displayed, and the scene displayed in the area 557 also change accordingly. Similarly, as the object 552 that is selected by the user on the screen 550 changes, the object 552 (the object 553) that is highlighted and displayed, the area 554 (the area 555) that is highlighted and displayed, and the scene displayed in the area 557 also change accordingly.

A text 560 is similar to the text 510.

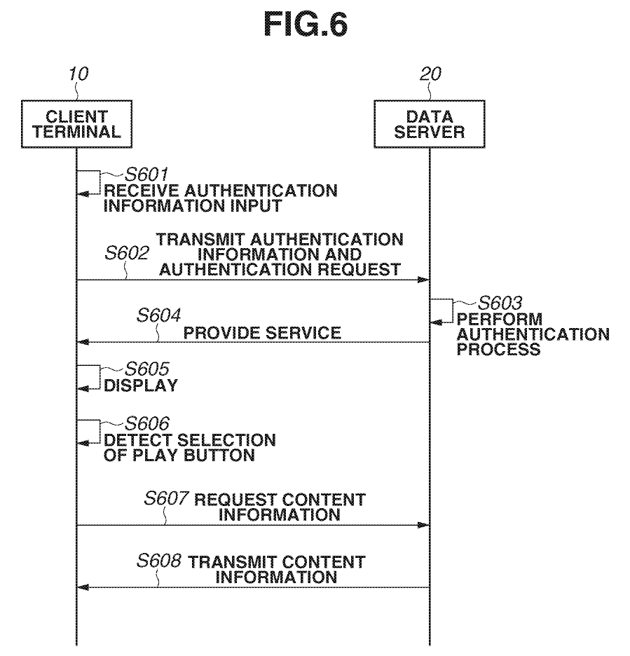

FIG. 6 is a sequence diagram illustrating an example of a process performed by the data server 20 and the client terminal 10 in a case where the data server 20 provides a content service to the client terminal 10. The process is started in a case where the service application is activated on the client terminal 10 by the user. In other words, the process is started in a case where the CPU 11 of the client terminal 10 detects a user operation and activates the service application by loading a program stored in the storage 14 into the RAM 13. The CPU 11 activates the service application and displays various screens necessary for the user to use the service on the operation unit 17.

If the configuration is capable of demonstrating the effect of the present disclosure, it is not required to perform all of the processes described below. Furthermore, the process order may be changed, or an additional process may be included.

In step S601, the CPU 11 of the client terminal 10 displays an authentication information input screen (not illustrated) on the operation unit 17, and the user inputs authentication information required to use the service application. At this time, the user inputs the authentication information using the keyboard of the operation unit 17 or a software key displayed on the operation unit 17. As a result, the CPU 11 accepts the authentication information that is required to use the service application and log in to the account corresponding to the user via the operation unit 17.

The authentication information refers to, for example, identification (ID), e-mail address, password, passcode, and other information corresponding to the account. In addition, a function available on the client terminal 10 may be used. For example, biometric authentication such as fingerprint authentication, face authentication, vein authentication, or iris authentication may be used.

In step S602, the CPU 11 transmits the authentication information accepted in step S601 and an authentication request (an instruction to perform an authentication process) to the data server 20 via the communication I/F 15. The CPU 21 of the data server 20 receives the authentication information and the authentication request via the communication I/F 25. At this time, since the information to be transmitted is highly confidential, the authentication information can be transmitted using an encrypted communication protocol.

In step S603, the CPU 21 of the data server 20 performs an authentication process using the received authentication information based on the authentication request received in step S602. Specifically, authentication information such as an account ID and password is stored in advance as a database in the storage 24, and in step S603, the CPU 21 searches the database for the received authentication information and performs an authentication process.

As a result of the search, in a case where the CPU 21 determines that the received authentication information is stored in the database, the CPU 21 determines that the authentication is successful, and in a case where the CPU 21 determines that the received authentication information is not stored in the database, the CPU 21 determines that the authentication is not successful. The sequence diagram illustrates an example of a process that is performed in a case where the authentication is successful. Furthermore, an access token corresponding to a user account issued based on the successful authentication may be transmitted or received during each communication thereafter.

In step S604, the CPU 21 starts providing the service to the client terminal 10. At this time, the CPU 21 may transmit information indicating the success of the authentication process.

Providing the service refers to providing the service provided by the data server 20, and in a case where, for example, the service is a moving image content delivery service, providing the service refers to a process such as a process for displaying a screen on the client terminal 10 to present a list of content that can be viewed by the user. At this time, the CPU 21 provides the service by transmitting not only screen information but also all information corresponding to the content, such as the content title, the length, the number of views, and the number of ratings.

The provision of the service is not unidirectional from the data server 20 but bidirectional between the data server 20 and the client terminal 10.

For example, the CPU 21 transmits the screen displaying the list of content to the client terminal 10, and in a case where desired content is selected from the displayed screen by the user, a request to transmit the content information is transmitted from the client terminal 10. In a case where the request is received, the CPU 21 of the data server 20 transmits the designated (selected) content information or a designated content screen such as a screen illustrated in FIGS. 3A, 3B, or 3C to the client terminal 10. The CPU 21 provides the service to the client terminal 10 as described above.

In step S605, the CPU 11 of the client terminal 10 displays various types of information and the screen provided by the data server 20 in step S604 on the operation unit 17. As a result, for example, a screen illustrated in FIGS. 3A, 3B, or 3C is displayed on the operation unit 17, and the user can use the service.

In step S606, the CPU 11 detects that a play button is selected. Specifically, the CPU 11 detects the selection of the object 333 in FIG. 3B or the object 363 in FIG. 3C and accepts the user instruction.

In step S607, the CPU 11 issues a request to transmit content information to the data server 20 based on the detection of the selection of the play button in step S606. Specifically, the CPU 11 transmits a request (an instruction to transmit content information) together with the content information to the data server 20 via the communication I/F 15, and the CPU 21 of the data server 20 receives the request and the content information via the communication I/F 25. At this time, the CPU 11 also transmits information such as a content name or ID, thereby enabling the data server 20 to identify the content.

In step S608, the CPU 21 of the data server 20 transmits content information corresponding to the received request to the client terminal 10 via the communication I/F 25 in response to the request received in step S607. In a case where the content is a moving image, moving image data is transmitted from the data server 20 to the client terminal 10 in step S608.

In a case where the content information (such as moving image data) is received via the communication I/F 15, the CPU 11 of the client terminal 10 displays, for example, a screen illustrated in FIGS. 4A, 4B, 4C, or 4D on the operation unit 17.

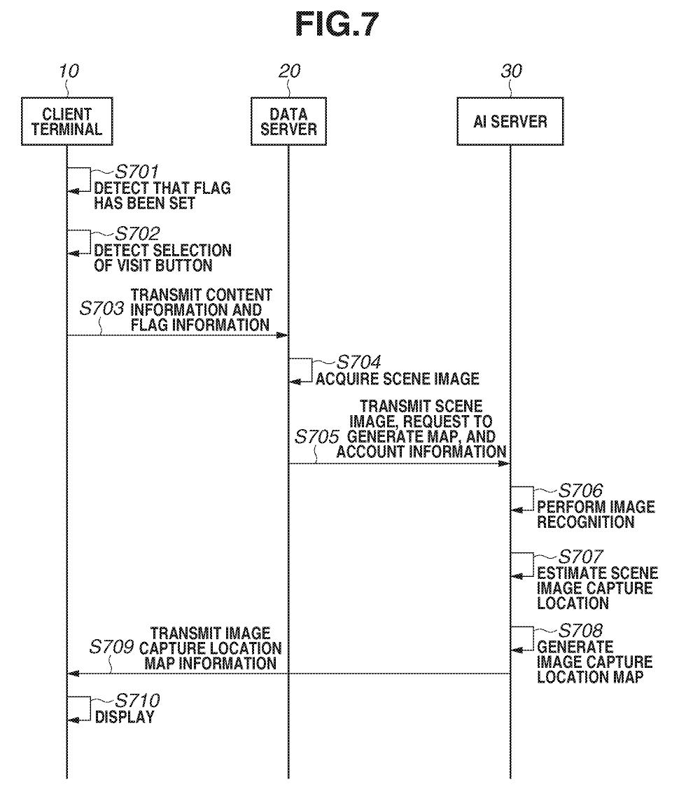

FIG. 7 is a sequence diagram illustrating an example of a process performed by the client terminal 10, the data server 20, and the AI server 30 in a case where an image capture location map is generated. The process is performed after the CPU 11 of the client terminal 10 displays the content on the operation unit 17 in step S608 illustrated in FIG. 6.

If the configuration is capable of demonstrating the effect of the present disclosure, it is not required to perform all of the processes described below. Furthermore, the process order may be changed, or an additional process may be included.

In step S701, the CPU 11 of the client terminal 10 detects that a flag has been set. Specifically, the user selects the object 404 displayed on the operation unit 17 of the client terminal 10 at any time when the displayed content is displayed (reproduced), and the CPU 11 detects this operation.

At this time, in a case where the content is, for example, moving image content, the user selects the object 404 and sets a flag when a scene that the user wishes to know its image capture location is displayed during the viewing of the moving image content. The scene refers to a particular scene from the content.

In a case where the object 404 is selected, the CPU 11 stores the flag information in the RAM 13 or the storage 14 in association with the timing (time) of the content and the scene.

Specifically, in a case where, for example, the object 404 is selected by the user when the scene at 3 minutes and 33 seconds of the moving image content with a total length of 5 minutes is displayed, the CPU 11 stores the flag information in association with the timing (time) information of 3 minutes and 33 seconds.

In step S702, the CPU 11 detects that a visit button, i.e., the object 309, 339, or 369, is selected. At this time, the CPU 11 acquires the flag information stored in step S701, such as information about the number of set flags and information stored in association with each flag.

In step S703, the CPU 11 transmits the content information and the flag information acquired in step S702 to the data server 20 via the communication I/F 15. The data server 20 receives the information transmitted from the CPU 11.

In step S704, the CPU 21 of the data server 20 acquires an image of the scene based on the content information and flag information received in step S703. Specifically, for example, the CPU 21 identifies the scene at the timing of the reception (flag information) in the content corresponding to the content ID (content information) received in step S703, and acquires an image of the scene (one frame of the moving image data).

In step S705, the CPU 21 transmits, to the AI server 30 via the communication I/F 25, the acquired image of the scene, a request to generate an image capture location map (an instruction to perform a map generation process), and information about the account (the client terminal 10) from which the information is transmitted in step S703. The AI server 30 receives the information transmitted by the CPU 21.

In step S706, the CPU 31 of the AI server 30 performs image recognition on the image of the scene received in step S705. This process is not required. The image recognition performed by the CPU 31 in step S706 refers to, for example, extracting a distinctive landscape, structure, or other notable elements, identifying which portion of the image of the scene is an area that is necessary for estimating the location, and recognizing only the necessary area. In addition, for example, the CPU 31 converts the image of the scene into a character string in natural language describing the image of the scene using the LLM or other models.

At this time, if the image includes, for example, a signboard on which a place name is described, performing an optical character reader (OCR) process on the characters and searching for the characters greatly contributes to the estimation of the image capture location. In step S706, the CPU 31 performs, in a sense, pre-processing necessary for an estimation process in the next step S707.

In step S707, the CPU 31 estimates the image capture location of the image of the scene received in step S705. Specifically, for example, the CPU 31 acquires necessary information by performing a search using various search engines (not illustrated) and various databases (not illustrated) using the image and character string that have undergone the pre-processing in step S706, and estimates the image capture location of the image of the scene. At this time, a variety of information related to the estimated image capture location, such as an image, address, postal code, place/facility name, related website, and telephone number is acquired.

In step S708, the CPU 31 generates an image capture location map based on the variety of information acquired in step S707 and corresponding to the image of the scene. At this time, for example, the CPU 31 acquires information necessary for generating a map, such as map information for displaying the object 501 or 551, and generates an image capture location map as illustrated in FIGS. 5A or 5B.

In step S709, the CPU 31 transmits the image capture location map information generated in step S708 to the client terminal 10 that the account corresponding to the account information received in step S705 has logged in from, and the client terminal 10 receives the image capture location map information. As a result, the AI server 30 provides the map service. The provision of the service may be not unidirectional from the AI server 30 but bidirectional between the AI server 30 and the client terminal 10.

In a case where the system has the configuration illustrated in FIG. 1B, in step S709, the CPU 31 transmits the image capture location map information generated in step S708 to the data server 20, and then the CPU 21 of the data server 20 transmits the image capture location map information to the client terminal 10, thereby providing the service.

In step S710, the CPU 11 of the client terminal 10 displays the image capture location map information received in step S709 on the operation unit 17. By completing the above process, the map service becomes available for use by the user. The map service screen illustrated in FIG. 5A or 5B may be displayed by the service application provided by the data server 20 or may be displayed as a service different from the service application, such as a browser.

If possible, the CPU 11 of the client terminal 10 may acquire the image of the scene in step S703. In this case, it is no longer necessary to transmit content information and flag information, so that the transmissions may be omitted. Furthermore, in this case, the next step S704 may be skipped. The client terminal 10 and the AI server 30 may communicate directly with each other.

While a single image of the scene (corresponding to one frame) is intended to be acquired in step S704 according to the present embodiment, the CPU 21 may be configured to also acquire preceding and following images (additional images) in a case where, for example, the content is moving image content. In this case, the acquired additional images are transmitted to the AI server 30 in step S705 and used as reference information for estimating the image capture location by the CPU 31 in step S707. This is expected to improve the accuracy of image capture location estimation.

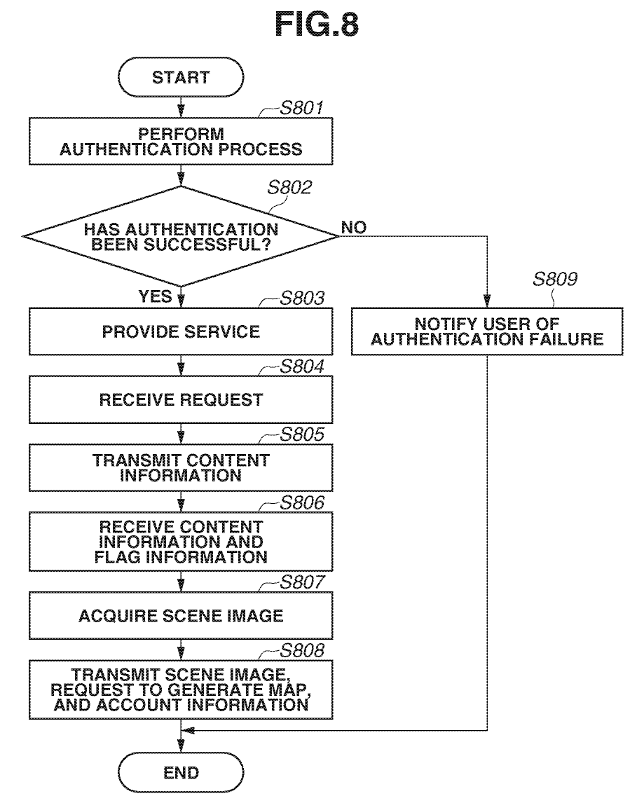

FIG. 8 is a flowchart illustrating an example of a process in which the data server 20 provides the service and issues a request to generate an image capture location map. The process is started in a case where the data server 20 receives authentication information and an authentication request from the client terminal 10 as described above with reference to step S602, and is an example of a process performed by the CPU 21 of the data server 20.

If the configuration is capable of demonstrating the effect of the present disclosure, it is not required to perform all of the processes described below. Furthermore, the process order may be changed, or an additional process may be included.

In step S801, as in step S603, the CPU 21 performs an authentication process using the received authentication information based on the received authentication request. Specifically, authentication information such as the account ID and password is stored in advance as a database in the storage 24, and in step S801, the CPU 21 searches the database for the received authentication information and performs an authentication process.

In step S802, the CPU 21 determines whether the authentication process in step S801 has been successful. Specifically, the CPU 21 searches the database stored in advance in the storage 24. As a result of the search, in a case where the CPU 21 determines that the received authentication information is stored in the database, the CPU 21 determines that the authentication is successful (YES in step S802), and the processing proceeds to step S803. An access token corresponding to a user account issued based on the successful authentication may be transmitted or received during each communication thereafter. On the other hand, in a case where the CPU 21 determines that the received authentication information is not stored in the database, the CPU 21 determines that the authentication is not successful (NO in step S802), and the processing proceeds to step S809.

In step S809, the CPU 21 generates a message and screen to provide notification of the failure of the authentication process and transmits the generated message and screen to the client terminal 10 via the communication I/F 25, thereby notifying the user of the authentication failure. In a case where the CPU 21 completes the process, the process illustrated in the flowchart is terminated.

In step S803, as in step S604, the CPU 21 starts providing the service to the client terminal 10. At this time, the CPU 21 may transmit information indicating the success of the authentication process.

Providing the service refers to providing the service provided by the data server 20, and in a case where, for example, the service is a moving image content delivery service, providing the service refers to a process such as a process for displaying, on the client terminal 10, a screen that presents a list of content that can be viewed by the user. At this time, the CPU 21 provides the service by transmitting not only screen information but also all information corresponding to the content, such as the content title, the length, the number of views, and the number of ratings.

The provision of the service is not unidirectional from the data server 20 but bidirectional between the data server 20 and the client terminal 10.

For example, the CPU 21 transmits the screen displaying the list of content to the client terminal 10, and in a case where desired content is selected from the displayed screen by the user, a request to transmit the content information is transmitted from the client terminal 10. In a case where the request is received, the CPU 21 of the data server 20 transmits the designated (selected) content information or a designated content screen such as a screen illustrated in FIGS. 3A, 3B, or 3C to the client terminal 10. The CPU 21 provides the service to the client terminal 10 as described above.

In step S804, as in step S607, the CPU 21 receives a content information request from the client terminal 10. At this time, the CPU 21 also receives information such as a content name or ID to identify the content in the subsequent step S805.

In step S805, as in step S608, the CPU 21 transmits content information corresponding to the received request to the client terminal 10 via the communication I/F 25 in response to the request received in step S804. For example, in a case where the content is a moving image, the CPU 21 transmits moving image data to the client terminal 10.

In step S806, as in step S703, the CPU 21 receives the content information and the flag information from the client terminal 10.

In step S807, as in step S704, the CPU 21 acquires an image of the scene based on the content information and flag information received in step S806. Specifically, for example, the CPU 21 identifies the scene at the timing of the reception (flag information) in the content corresponding to the received content ID (content information), and acquires an image of the scene (one frame of the moving image data).

In step S808, as in step S705, the CPU 21 transmits, to the AI server 30, the image of the scene acquired in step S807, a request to generate an image capture location map (an instruction to perform a map generation process), and information about the account (the client terminal 10) from which the information is transmitted in step S806.

In a case where the CPU 21 completes the process, the process is terminated.

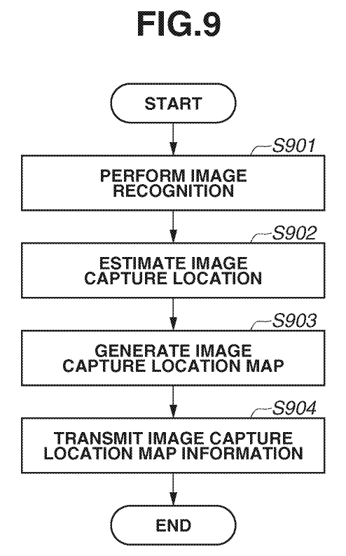

FIG. 9 is a flowchart illustrating an example of a process in which the CPU 31 of the AI server 30 generates an image capture location map. The process is started in a case where the AI server 30 receives the image of the scene, the request to generate a map, and the account information from the data server 20 as described above with reference to step S705, and is an example of a process performed by the CPU 31 of the AI server 30.

If the configuration is capable of demonstrating the effect of the present disclosure, it is not required to perform all of the processes described below. Furthermore, the process order may be changed, or an additional process may be included.

In step S901, as in step S706, the CPU 31 performs image recognition on the received image of the scene. This process is not required. The image recognition performed by the CPU 31 in step S901 refers to, for example, extracting a distinctive landscape, structure, or other notable elements, identifying which portion of the image of the scene is an area that is necessary for estimating the location, and recognizing only the necessary area. In addition, for example, the CPU 31 converts the image of the scene into a character string in natural language describing the image of the scene using an LLM or other models.

At this time, if the image includes, for example, a signboard on which a place name is described, performing an OCR process on the characters of the place name and searching for the character string greatly contributes to the enhancement of the accuracy of the estimation of the image capture location. In step S901, the CPU 31 performs, in a sense, pre-processing necessary for an estimation process in the next step S902.

In step S902, as in step S707, the CPU 31 estimates the image capture location of the received image of the scene. Specifically, for example, the CPU 31 estimates the image capture location of the image of the scene by performing a search using various search engines (not illustrated) and various databases (not illustrated) using the image and character string that have undergone the pre-processing in step S901. At this time, a variety of information related to the estimated image capture location, such as an image, address, postal code, place/facility name, related website, and telephone number is acquired.

In step S903, as in step S708, the CPU 31 generates an image capture location map based on the variety of information acquired in step S902 and corresponding to the image of the scene. At this time, for example, the CPU 31 acquires information necessary for generating a map, such as map information for displaying the object 501 or 551, and generates an image capture location map as illustrated in FIGS. 5A or 5B.

In step S904, as in step S709, the CPU 31 transmits the image capture location map information generated in step S903 to the client terminal 10 based on the received account information, and the client terminal 10 receives the image capture location map information. As a result, the AI server 30 provides the map service. In a case where step S904 is complete, the process is terminated.

The provision of the service may be not unidirectional from the AI server 30 but bidirectional between the AI server 30 and the client terminal 10. In a case where the process is complete, the process is terminated. At this time, the CPU 31 may store a record, as a log, indicating that the location of the scene from the content has been estimated and transmitted in the storage 34.

As described above, according to the present embodiment, if the user browsing (viewing) content wishes to know the image capture location of a scene from the content, the user can view information about the image capture location of the scene in map format by setting a flag and selecting the visit button. At this time, the user selects the object 404, sets a flag, and selects the object 309, 339, or 369, thereby enabling an image capture location map to be generated and displayed automatically without the user having to perform a search or other operations.

As illustrated in FIGS. 4A to 4D, 5A, and 5B, after the user performs a single operation (to select the object 309, 339, or 369), a screen illustrated in FIGS. 5A or 5B is displayed without the user having to perform another operation. Further, at this time, geographical information about eight image capture locations is displayed by the single operation in a case where flags are set for eight locations by the user as in the present embodiment.

In a case where the estimation of the image capture location in step S902 fails, the scene image capture location does not have to be displayed on the map. In this case, for example, an error message or display indicating that the estimation of the image capture location has failed may be displayed.

The conventional technology requires the user to, for example, capture a screenshot or the like of a scene from the content, search for it using a search engine or the like to identify the location, and investigate information about the location on their own. However, this burden can be significantly reduced with the present disclosure using AI. This makes it easier for the user who is a fan of the content to, for example, visit each image capture location, which is referred to as a pilgrimage, thereby making it possible to enhance the user experience.

Using AI and accumulated databases, the present disclosure makes it possible to estimate an image capture location even in a case where the content is a game, animation, or manga, as well as a television program, drama, or movie captured in the real world. In a case where the content is an animation or computer graphics (CG), the image capture location according to the present embodiment refers to a thematic location depicted in the content.

In a case where the estimation of the image capture location by the AI server 30 is not necessary because the image capture location information about each scene from the content is managed by the data server 20 or published, the image capture location map described above may be generated without the estimation.

While geographical information about the image capture location corresponding to the scene for which a flag is set by the user is displayed on the map in the example according to the present embodiment, geographical information about, for example, every scene or major scene may be displayed on the map without selection by the user. At this time, all the content data may be transmitted to the generative AI so that in a case where, for example, a scene is selected at regular intervals or a scene with a high number of views is selected, the generative AI acquires information about the image capture location corresponding to the selected scene. Furthermore, the image capture location of a scene that is not selected by the user may be displayed together with the image capture location of a scene that is selected by the user on the map.

In the system, for example, each server such as the data server 20 or the AI server 30 may be located outside Japan, and the client terminal 10 (hereinafter, referred to as “terminal apparatus”), which is a terminal apparatus, may be located within Japan. Even in this case, a file or data can be transmitted from each server to the terminal apparatus, and the terminal apparatus can receive the file or data.

Even in a case where each server is located outside Japan as described above, the file or data transmission and reception (transmission and reception) in the system is performed as a single process. Furthermore, considering that the system functions by receiving the file or data on the terminal apparatus located within Japan, the transmission and reception can be considered to occur within Japan.

Even in a case where, for example, each server is located outside Japan and the terminal apparatus is located within Japan, the terminal apparatus can achieve the major function of the system, and the effect of the function can be demonstrated within Japan. For example, even in a case where each server is located outside Japan, if the terminal apparatus constituting the system is located within Japan, it is possible to use the system within Japan using the terminal apparatus. In addition, the utilization of the system may impact, for example, the economic interests of the patent owner.

### Second Embodiment

A second embodiment of the present disclosure will be described. The second embodiment is an example in which while content is displayed (reproduced) on the client terminal 10, information about the image capture location of a scene from the displayed content is displayed on the operation unit 17.

The present embodiment does not involve the concept of setting a flag (object 404), and each time an object 441 corresponding to a visit button is selected, a process corresponding to each of steps S702 and S703 is performed. As a result, the client terminal 10 receives information about the image capture location of the scene displayed at the time of selection of the visit button, and displays the received information. The description of the present embodiment will focus mainly on differences from the above-described embodiment.

The object 441 on the screen 440 illustrated in FIG. 4C corresponds to the objects 309, 339, and 369. Information 442 indicates the image capture location of the scene displayed at the time of selection of the object 441. In reality, a delay in process execution is expected, but if it is assumed that the process does not take long, the information about the image capture location of the scene displayed at the time of selection of the object 441 by the user is displayed on the operation unit 17. The objects 401 to 403 are similar to those described above.

Since the object 441 is selected, the CPU 11 of the client terminal 10 detects that the visit button is selected, as in step S702. Next, as in step S703, the CPU 11 transmits content information and information about the scene displayed at the time of selection of the object 441 to the data server 20. Next, as in step S704, the CPU 21 of the data server 20 acquires an image of the scene. Next, as in step S705, the CPU 21 transmits the image of the scene and account information to the AI server 30.

Next, as in steps S706 and S707, the CPU 31 of the AI server 30 performs image recognition and estimation of the image capture location of the scene. Next, as in step S709, the CPU 31 transmits the information about the image capture location of the scene to the corresponding account (client terminal). Lastly, the CPU 11 of the client terminal 10 displays the received information about the image capture location of the scene as illustrated by the information 442.

On the other hand, the information 442 in the example of the screen 460 illustrated in FIG. 4D is similar to that described above with reference to FIG. 4C. The example illustrated in FIG. 4D differs from that illustrated in FIG. 4C in that it illustrates a case where the information about the image capture location of the scene displayed on the operation unit 17 is constantly displayed without user selecting the object 441.

In this case, even though the object 441 is not selected, the CPU 11 of the client terminal 10 transmits the content information and information about the scene displayed on the operation unit 17 to the data server 20, as in step S703. Subsequently, the process described above with reference to FIG. 4C is performed, and while the content is displayed (reproduced), the information about the image capture location of the displayed scene is constantly displayed on the operation unit 17.

Performing the process according to the present embodiment enables the user to browse content and be informed of the information about the image capture location of the displayed scene simultaneously.

### Third Embodiment

A third embodiment of the present disclosure will be described. The third embodiment is an example in which the accuracy of the estimation of the image capture location is enhanced by prompting the user to confirm an estimation result based on the number of times the CPU 31 of the AI server 30 has generated maps during generation of an image capture location map. The description of the present embodiment will focus mainly on differences from the above-described embodiments.

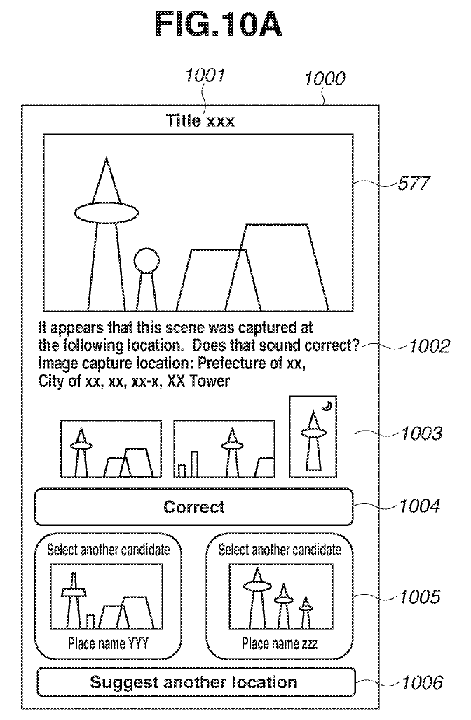

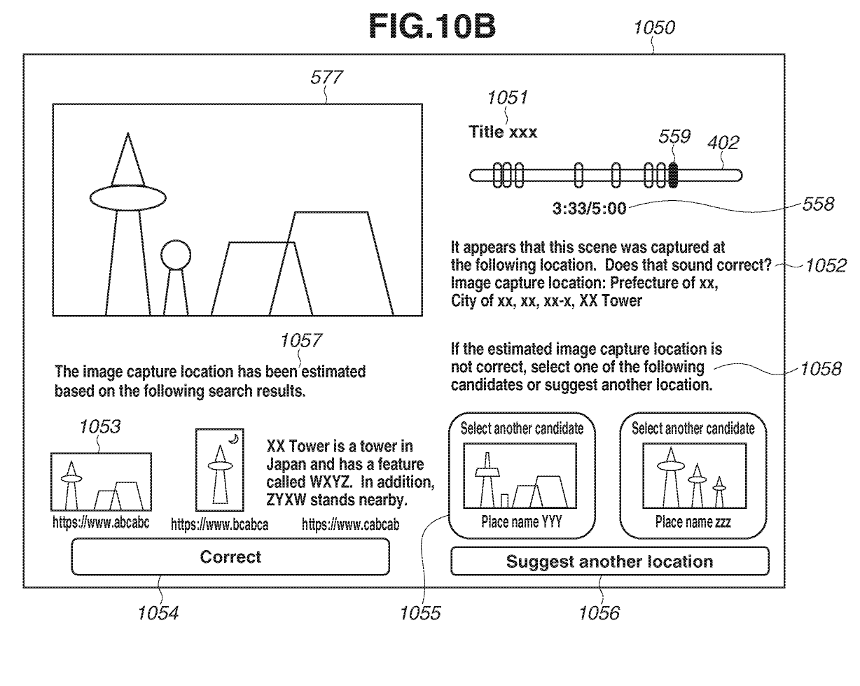

FIGS. 10A and 10B are diagrams illustrating examples of screens that are generated by the AI server 30 and configured to prompt the user to confirm an estimated image capture location. Screens 1000 and 1050 respectively illustrated in FIGS. 10A and 10B are examples of screens displayed on the operation unit 17 of the client terminal 10.

Several examples are illustrated because the map service screen displays different information depending on, for example, the size of the operation unit 17 of the client terminal 10 that displays the screen. The map service screen may display the same information regardless of the client terminal 10.

The screen 1000 illustrated in FIG. 10A herein is an example of the map service screen displayed on the operation unit 17 of the client terminal 10 such as a smartphone or compact tablet terminal. On the other hand, the screen 1050 illustrated in FIG. 10B is an example of the map service screen displayed on the operation unit 17 of the client terminal 10 such as a PC, large tablet terminal, or projector.

The object 402, the area 558, the object 559, and an area 577 on the screens 1000 and 1050 are similar to those described above, so that the description will be omitted.

FIG. 10A is a diagram illustrating an example of the map service screen provided by the AI server 30 and a first example of the screen configured to prompt the user to confirm an estimated image capture location. The screen 1000 is a screen including various objects, areas, and other items described below. In a case where the screen 1000 is displayed on the operation unit 17 of the client terminal 10, the user replies, and when the reply result is received by the CPU 31 of the AI server 30, the image capture location map is updated and used as reference information in subsequent estimations of the image capture location.

A text 1001 is a character string that represents a title of the content corresponding to the generated image capture location map.

A text 1002 is a character string that is a question sentence to the user and inquires (prompts the user to confirm) whether the estimated location is correct. In the illustrated example according to the present embodiment, the text 1002 displays information (name) about the estimated image capture location. The text 1002 may be configured to also display other information about the image capture location, such as an address, in addition to the name.

An area 1003 is an area where information, such as an image, related to the estimated location is displayed. For example, an image that is used in generating an image capture location map, is accumulated in a database, such as a web server, and captures the estimated location is displayed.

An object 1004 is a button used by the user to reply to the question of the text 1002, and in the example of the screen 1000, a character string indicating a positive reply (that the estimated image capture location is correct) is displayed in the object 1004. The information displayed in the object 1004 is not limited to a positive reply or character string. For example, a symbol, such as a circle mark, cross mark, or check mark, may be displayed in the object 1004.

According to the present embodiment, the user checks the scene of the content displayed in the area 577 and information displayed in the text 1002 and the area 1003, and determines whether the image capture location is correct. In a case where the user determines that the image capture location is correct, the user selects the object 1004. In a case where the object 1004 is selected by the user, a reply is transmitted from the client terminal 10 to the AI server 30 as in step S1005 described below.

An object 1005 is a button used by the user to suggest another candidate different from the image capture locations specified in, for example, the text 1002 or the area 1003. In the example of the screen 1000, information about the location (such as a place name or address) and an image of the location are displayed in the object 1005. It is not required to display all of these in the object 1005, and other information may also be displayed.

According to the present embodiment, the user checks the scene of the content displayed in the area 577 and information displayed in the text 1002 and the area 1003 and determines whether the image capture location is correct. In a case where the user determines that the image capture location is not correct (is wrong), the user selects the object 1005.

In particular, in a case where the user determines that the candidate represented by the object 1005 is correct after having determined that the image capture location is wrong, the user selects the corresponding object 1005. In a case where the object 1005 is selected by the user, a reply is transmitted from the client terminal 10 to the AI server 30 as in step S1005 described below.

According to the present embodiment, the image capture location indicated by the text 1002 and the area 1003 is different from the image capture location indicated by the object 1005. In other words, the object 1005 is an object configured to suggest another image capture location to the user. However, the candidate for the image capture location displayed in the object 1005 may be the same as the image capture location indicated by the text 1002 and the area 1003, and may display a location from which a first surface of the structure is visible and a location from which a second surface different from the first surface is visible.

An object 1006 is a button used by the user to suggest, for example, an image capture location other than the image capture location indicated by the text 1002 and the area 1003 and the image capture location indicated by the object 1005, as the image capture location of the scene displayed in the area 577.

According to the present embodiment, the user checks the scene of the content displayed in the area 577 and information displayed in the text 1002 and the area 1003, and determines whether the image capture location is correct. In a case where the user determines that the image capture location is not correct (is wrong), the user selects the object 1006.

In particular, in a case where the user determines that none of the candidates indicated by the object 1003 is correct after determining that the image capture location is wrong, the user selects the object 1006.

In a case where the object 1006 is selected, for example, an input field for inputting location information is displayed, and the user can input information about the correct image capture location via the operation unit 17. In a case where the information about the image capture location is input by the user, the input information is transmitted as a reply from the client terminal 10 to the AI server 30 as in step S1105 described below.

Selection of the object 1006 by the user may display another candidate place (e.g., the object 1005) or enable the user to upload an image. In step S1105, the former case is similar to a case where the object 1005 is selected, and in the latter case, the upload image is transmitted and used in steps S1007 and S1008.

FIG. 10B is a diagram illustrating an example of the map service screen provided by the AI server 30 and a second example of the screen configured to prompt the user to confirm an estimated image capture location. The screen 1050 is a screen including various objects, areas, and other items described below. In a case where the screen 1050 is displayed on the operation unit 17 of the client terminal 10, the user replies, and the reply result is received by the CPU 31 of the AI server 30, the image capture location map is updated and used as reference information in subsequent estimations of the image capture location.

A text 1051 is similar to the text 1001. A text 1052 is similar to the text 1002.

An area 1053 is similar to the area 1003. In the example of the screen 1050 illustrated in FIG. 10B, the content of a literature, article, or the like and information, such as a URL, specifying the location where the content is displayed (managed) are further displayed in addition to the images displayed on the screen 1000. Furthermore, selection of the image or URL by the user may display detailed information.

An object 1054 is similar to the object 1004. An object 1055 is similar to the object 1005. An object 1056 is similar to the object 1006.

A text 1057 is an example of a message displayed to notify the user that the image capture location described in the text 1052 is estimated based on the information displayed in the area 1053.

It is not required to display the text 1057.

A text 1058 is an example of a message configured to prompt the user to suggest another image capture location by selecting the object 1055 or 1056 in a case where the estimated image capture location does not match the image capture location of the content. It is not required to display the text 1058.

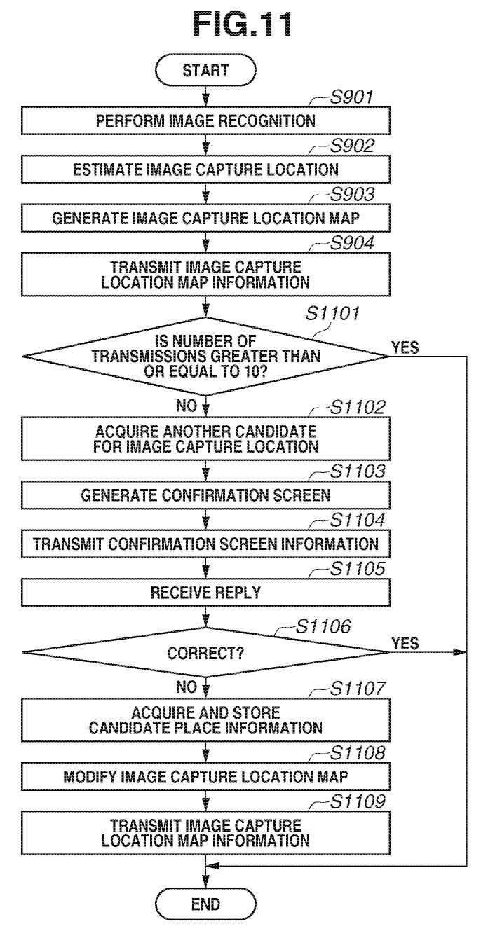

FIG. 11 is a flowchart illustrating an example of a process designed to improve the accuracy of an image capture location estimated by the CPU 31 of the AI server 30. As in FIG. 9, the process is started in a case where the AI server 30 receives the image of the scene, the request to generate a map, and the account information from the data server 20 as described above with reference to step S705, and is an example of a process performed by the CPU 31 of the AI server 30. Steps S901 to S904 in the first half of the flowchart are similar to those described above with reference to FIG. 9, so that the description will be omitted.

If the configuration is capable of demonstrating the effect of the present disclosure, it is not necessary to perform all of the processes described below. Furthermore, the process order may be changed, or an additional process may be included.

In step S1101, the CPU 31 determines whether the number of times the location of the scene of the content is estimated and transmitted is greater than or equal to a threshold. While the threshold is set to 10 according to the present embodiment, the threshold is not limited to 10. Specifically, the CPU 31 searches the log recorded in the storage 34, and in a case where the CPU 31 determines that the number of transmissions is greater than or equal to the threshold, as a result of the search (YES in step S1101), the process is terminated, and in a case where the CPU 31 determines that the number of transmissions is less than the threshold (NO in step S1101), the processing proceeds to step S1102.

In step S1102, the CPU 31 acquires another candidate for the image capture location. Specifically, the CPU 31 acquires, for example, information about an image capture location that is not included as a final candidate among a plurality of image capture locations detected during estimation of the image capture location in step S902. According to the present embodiment, the CPU 31 records the information (search results) in the storage 34 during the image capture location estimation process in step S902. The CPU 31 may be configured to acquire (search for) an image capture location again based on the received image of the scene image.

In step S1103, the CPU 31 generates a confirmation screen as illustrated in, for example, FIGS. 10A or 10B. Specifically, the CPU 31 generates the text 1002 or 1052 based on the image capture location estimated in step S902, and generates information to be displayed in the area 1003 or 1053 based on an image, literature, and the like obtained during the search. The CPU 31 generates the object 1005 or 1055 based on information about the other candidate for the image capture location acquired in step S1102. The CPU 31 generates the area 577 based on the received image of the content.

In a case where the AI server 30 acquires flag information or other information input to the client terminal 10, the CPU 31 can generate the object 402, the area 558, and the object 559 on the screen 1050 based on the acquired information.

In step S1104, the CPU 31 transmits information about the confirmation screen generated in step S1103 to the client terminal 10 based on the received account information.

As a result, the screen 1000 or 1050 illustrated in FIGS. 10A or 10B is displayed on the operation unit 17 of the client terminal 10. In a case where either confirmation screen is displayed, the user selects one of the objects 1004, 1005, 1006, 1054, 1055, and 1056.

In step S1105, the CPU 31 receives a reply from the client terminal 10 (the corresponding account). In a case where the object 1004 or 1054 is selected by the user, the CPU 31 receives information, such as a command, indicating that the image capture location estimated in step S902 is correct.

In a case where the object 1005 or 1055 is selected by the user, the CPU 31 receives the corresponding ID of the object and information about the image capture location, such as a place name or address. The corresponding ID refers to the ID that is defined for the object 1005 or 1055 by the CPU 31 in step S1104 and from which location information can be identified.

In a case where the object 1006 or 1056 is selected by the user, the CPU 31 receives information input by the user upon selecting the object.

In step S1106, the CPU 31 determines whether the image capture location estimated in step S902 is correct based on the reply received from the user in step S1105. Specifically, in a case where the reply received in step S1105 is information, such as a command, indicating that the image capture location is correct, the CPU 31 determines that the image capture location estimated in step S902 is correct. In a case where the CPU 31 determines that the image capture location is correct (YES in S1106), the process is terminated. On the other hand, in a case where the reply received in step S1105 is not any of the information described above, such as the ID, information about the image capture location, or information input by the user, the CPU 31 determines that the image capture location estimated in step S902 is not correct. In a case where the CPU 31 determines that the image capture location is not correct (NO in step S1106), the processing proceeds to step S1107.

In step S1107, the CPU 31 acquires candidate place information based on the reply received from the user in step S1105 and stores the acquired candidate place information. Specifically, the CPU 31 analyzes the reply received in step S1105 and acquires information about the image capture location (including information corresponding to the ID). Alternatively, in a case where the information input by the user is received in step S1105, the search is performed based on the received information and acquires information about the image capture location. The CPU 31 stores the acquired information about the image capture location in the storage 34.

At this time, the CPU 31 stores the information about the image capture location in association with the image of the scene and flag information. Thus, the stored information can be used in subsequent estimations of the image capture location for the same scene, thereby making it possible to improve the accuracy of the subsequent estimations of the image capture location.

In step S1108, the CPU 31 generates an image capture location map, as in step S903, based on the candidate place information (information about the image capture location) acquired in step S1107 and modifies the map.

Step S1101 and subsequent steps are performed for each scene. In other words, in a state where eight flags are set by the user as described above in the first embodiment, eight image capture locations are displayed on the map. In other words, in step S1101, the CPU 31 checks the number of transmissions for each of the eight scenes. Thus, in a case where information indicating that only a few of the eight image capture locations do not match the image capture location is received in step S1105, the CPU 31 may modify only these few image capture locations and generates a map in step S1108.

In step S1109, the CPU 31 transmits information about the image capture location map modified in step S1108 to the client terminal 10 based on the received account information. At this time, only the information about the image capture locations modified in step S1108 may be transmitted, or information including the information about the image capture locations that do not need to be modified (that match the image capture location of the scene) may be transmitted. In a case where the CPU 31 completes step S1109, the process is terminated.

In a case where the information acquired in step S1105 or S1107 is stored in the storage 34 when the CPU 31 performs the process according to the present embodiment, the CPU 31 performs location estimation considering the stored information in step S902. This improves the accuracy of the image capture location map generated by the CPU 31 of the AI server 30.

The order of the steps in the process illustrated in the flowchart in FIG. 11 may be changed, or only a necessary process may be performed. For example, a process of determining a threshold as in step S1101 may be performed at the beginning of the process, thereby making it possible to determine whether the scene represented by the received image has been estimated previously. In a case where the scene has been estimated previously, it is possible to identify the image capture location without performing the process of estimating the image capture location again. Furthermore, in a case where the scene is stored in association with information indicating that the object 1004 or 1054 is selected by the user, this further contributes to the enhancement of the accuracy of the map.

### Fourth Embodiment

### Report System

A fourth embodiment of the present disclosure will be described. The fourth embodiment is an example in which in a case where it is not appropriate to publish location information through a generated image capture location map, the user can report this information. The description of the present embodiment will focus mainly on differences from the above-described embodiments.

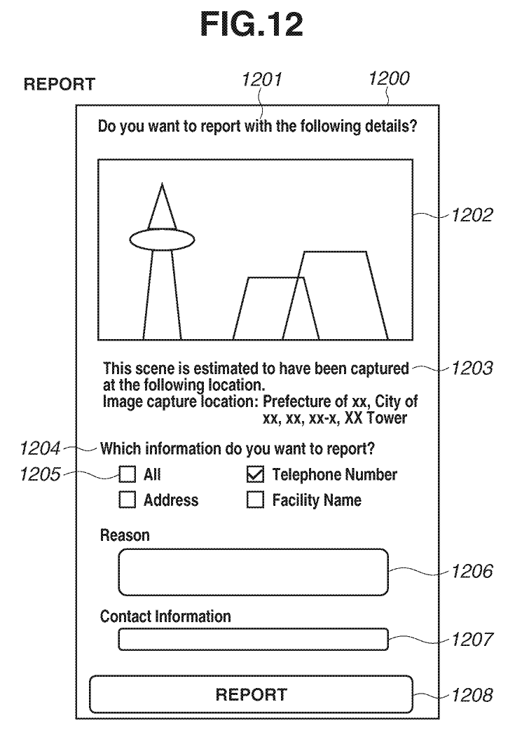

FIG. 12 is a diagram illustrating an example of a screen that is generated by the AI server 30 and used by the user to report an image capture location. A report screen 1200 is a screen used by the user to report an image capture location to prevent some or all of the information about the reported location from being displayed on an image capture location map in a case where the user determines that it is not appropriate to publish the image capture location.

The report screen 1200 is a screen that can be called from the map service screen illustrated in FIGS. 10A or 10B and is displayed on the operation unit 17 of the client terminal 10 in a case where a menu (not illustrated) or another item included in the area 504 or 554 is selected. The report screen 1200 is a screen including various objects, areas, and other items described below.

A text 1201 is an example of a message indicating that the screen 1200 is a report screen, and may be a screen title.

An area 1202 is an area where information about the image capture location that the user intends to report is displayed, and an image representing the image capture location is displayed in the illustrated example according to the present embodiment.

A text 1203 indicates that the location displayed in the area 1202 is an estimated image capture location, and presents information about the image capture location. In the illustrated example according to the present embodiment, the text 1203 displays information (name) about the estimated image capture location. The text 1203 may be configured to also display other information about the image capture location, such as an address, in addition to the name.

A text 1204 is an example of a message that is a question sentence to the user and inquires which published information about the image capture location the user wishes to report.

Objects 1205 are objects that are commonly referred to as check buttons and displayed based on the type of the published information. The user can select the object 1205 that corresponds to the location information the user wishes to report. In the example illustrated in FIG. 12, the user determines that it is not appropriate to publish the telephone number of the image capture location, and the screen 1200 in a state where the object 1205 corresponding to the telephone number is selected is illustrated.

An area 1206 is an input field for entering the reason for reporting by the user. An area 1207 is an input field for entering contact information about the user submitting the report so that an administrator of the service can contact the user having submitted the report.

It is not required to display the area 1206 or 1207. For example, in a case where the administrator of the service can contact the user based on account information or other information, the area 1207 may be hidden.

An object 1208 is a button used by the user to submit a report, and in a case where the object 1208 is selected, information about the selected object 1205, information input to the area 1206, and information input to the area 1207 are transmitted to the AI server 30. As a result, the report is submitted by the user.

In a case where a report is submitted, the CPU 31 of the AI server 30 stores the report and details of the report in association with the image capture location in the storage 34. The administrator of the service reviews the details of the report and can take measures such as suspending publication of the information, if necessary.

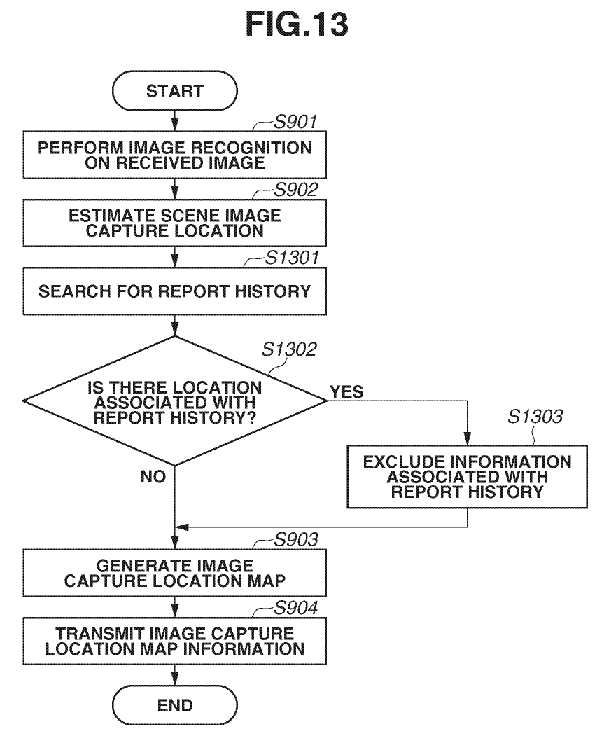

FIG. 13 is a flowchart illustrating an example of a process for generating an image capture location map in a case where there is a report history. As in FIG. 9, the process is started in a case where the AI server 30 receives the image of the scene, the request to generate a map, and the account information from the data server 20 as described above with reference to step S705, and is an example of a process performed by the CPU 31 of the AI server 30. Steps S901 to S904 in the first half of the flowchart are similar to those described above with reference to FIG. 9, so that the description will be omitted.

In a case where the object 1208 has been selected and reported previously, information indicating the history of the report is stored in association with the information about the image capture location prior to the process. If the configuration is capable of demonstrating the effect of the present disclosure, it is not necessary to perform all of the processes described below. Furthermore, the process order may be changed, or an additional process may be included.

In step S1301, the CPU 31 searches for a report history associated with the image capture location estimated in step S902.

Specifically, the CPU 31 searches the storage 34 and checks whether a report history is stored in association with the location estimated in step S902, and whether information indicating that the administrator of the service has taken measures such as suspending effect is stored. In the example according to the present embodiment, in a case where there is a report, the publication of the information is suspended based on the report regardless of the judgement of the administrator of the service.

In step S1302, the CPU 31 determines whether a report history is stored in association with the location estimated in step S902, based on step S1301. In a case where the CPU 31 determines that a report history is stored (YES in step S1302), the processing proceeds to step S1303, and in a case where the CPU 31 determines that a report history is not stored (NO in step S1302), the processing proceeds to step S903.

In step S1303, the CPU 31 performs a process for excluding the location associated with the previous report history from the map generation process in step S903 based on the details of the report history detected in step S1301. In a case where the reported information is a portion of the published information about the image capture location, the CPU 31 performs the process to exclude the portion of the information from the map generation process in step S903.

As a result of the above-described process, the information about the image capture location determined to be inappropriate for publication based on the previous user report is no longer published. This applies to all users of the service.

While the process for excluding the location or information reported before the map is generated is performed in the example illustrated in FIG. 13, a map for the reported location or information may also be generated, and the corresponding item may be hidden to prevent the information from being published.

As a result, in a case where it is not appropriate to publish location information through a generated image capture location map, the user can report this information so that the published location information is no longer published.

### Other Embodiments

The present disclosure may also be implemented by supplying a program that realizes one or more functions of the above-described embodiments to a system or apparatus via a network or a storage medium, and causing one or more processors in a computer of the system or apparatus to read and execute the program. Furthermore, the functions may also be implemented by a circuit (e.g., an application specific integrated circuit (ASIC)) that realizes one or more of the functions.

The present disclosure reduces the burden on the user required to identify an image capture location of a scene from content.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-226780, filed December 23, 2024, which is hereby incorporated by reference herein in its entirety.

What is claimed is:

1. An information processing apparatus configured to provide content to an external apparatus, the information processing apparatus comprising:
a reception unit configured to receive information corresponding to a scene selected from the content by a user;
an acquisition unit configured to acquire geographical information corresponding to the selected scene represented by the received information corresponding to the scene; and
a transmission unit configured to transmit the acquired geographical information corresponding to the selected scene to the external apparatus.

2. The information processing apparatus according to claim 1, wherein the geographical information is an address of the selected scene.

3. The information processing apparatus according to claim 1, wherein the geographical information is a place name of the selected scene.

4. The information processing apparatus according to claim 1, wherein the content is a moving image.

5. The information processing apparatus according to claim 4, wherein the information corresponding to the selected scene is an elapsed time of the content.

6. The information processing apparatus according to claim 1, wherein the information corresponding to the selected scene is image data representing the scene.

7. The information processing apparatus according to claim 1, wherein the geographical information is displayed as a map.

8. The information processing apparatus according to claim 1, wherein in a case where an object is selected by the user, the geographical information is displayed without performing any operation after the object is selected.

9. The information processing apparatus according to claim 1, wherein in a case where a predetermined number of objects is selected by the user, the predetermined number of pieces of geographical information is displayed.

10. The information processing apparatus according to claim 9, wherein the object is selected by the user in a state where the content is displayed.

11. The information processing apparatus according to claim 1, wherein the acquisition unit acquires, from a server having a generative artificial intelligence (generative AI) function, the geographical information corresponding to the selected scene represented by the received information corresponding to the scene.

12. The information processing apparatus according to claim 11, wherein the transmitted geographical information is displayed on a same screen as an image of a location indicated by the geographical information, information about a second location different from the location indicated by the geographical information, an image of the second location, and an object used by the user to suggest a third location which is not displayed.

13. An information processing apparatus configured to provide content, the information processing apparatus comprising:
a reception unit configured to receive, from a first external apparatus, information corresponding to a scene selected from the content by a user; and
a transmission unit configured to transmit, to a second external apparatus, information indicated by the selected scene represented by the received information corresponding to the scene,
wherein the second external apparatus acquires geographical information corresponding to a scene indicated by the transmitted information indicated by the scene selected by the user, and the acquired geographical information is displayed on the first external apparatus.

14. An information processing apparatus comprising:
a display unit configured to display content;
an acceptance unit configured to accept, from a user, selection of a scene from the displayed content;
a transmission unit configured to transmit information corresponding to the selected scene to an external apparatus; and
a reception unit configured to receive geographical information corresponding to the selected scene and acquired in a case where the information corresponding to the scene is transmitted by the transmission unit,
wherein the display unit is configured to display the received geographical information.
